(19) United States
(12) Patent Application Publication
(10) Pub. No.: US 2009/0072980 A1
(43) Pub. Date: Mar. 19, 2009

(54) Alarm device and water-cooling heat dissipation alarm system

(76) Inventor: Chia-Chun Cheng, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,081

(22) Filed: Jul. 16, 2008

(30) Foreign Application Priority Data
Sep. 14, 2007 (TW) 96215537

(51) Int. Cl. G08B 21/00

(52) U.S. Cl. 340/606

(57) ABSTRACT

The water-cooling heat dissipation alarm system according to the present invention comprises a water-cooling heat dissipation system and an alarm device, in which the water-cooling heat dissipation system is mutually connected to a water block, a heat exchanger, a water tank and a circulation pump through the pipe, wherein the circulation pump outputs a frequency signal being in proportional to the rotation speed thereof. The alarm device is placed in the circulation pump, which receives the frequency signal outputted from the circulation pump and determines action conditions in the water flow and the circulation pump, then performs alarm operation based the determination in order to provide precise system abnormality alarm.

### BACKGROUND OF THE INVENTION

1. Field of the Invention

The present invention is related to an alarm device and a water-cooling heat dissipation alarm system; in particular, to an alarm device and an alarm system which determines the quantity of fluid flow in the water-cooling heat dissipation system by using a frequency signal generated by the pump.

2. Description of Related Art

Due to the increasing demand for processing speed in current information equipment, the industry has developed many sophisticated, high frequency, high speed chip sets which inevitably generate additional heat. For this phenomenon, general heat dissipation modules are gradually insufficient and thus water-cooling heat dissipation system are sometimes applied.

Refer to FIG. 1, where a structural diagram of a conventional water-cooling heat dissipation system is shown. The structure of the depicted water-cooling heat dissipation system is composed of a circulation pump 10, a water tank 14, a heat exchanger 16 and a water block 18, mutually connected by the pipes and forming a fluid circulation closed loop. The conventional water-cooling heat dissipation system uses the operation of the circulation pump 10 to cause the low temperature fluid WI in the water tank 14 to flow into the water block 18 through the pipe, and the water block 18 is in close proximity of the heat source 20 (e.g. CPU) to perform heat exchange. After the heat exchange, the high temperature fluid W2 flows from the water block 18 through the pipe and into the heat exchanger 16 for heat exchange. After the heat exchange, the constant temperature or low temperature fluid W3, through the pipe, flows from the heat exchanger 16 into the water tank 14, thus forming the circulated water-cooling heat dissipation.

Referring again to FIG. 1, the conventional water-cooling heat dissipation mostly uses liquid water as the medium for heat exchange and heat transfer; therefore, during the operation of the water-cooling heat dissipation system, if there is no water flow in the pipe or the amount of water flow is insufficient, the operation of the water-cooling heat dissipation will be affected.

As a result, a general alarm device is usually provided in the pipe of the water-cooling heat dissipation system in order to directly contact with the water flow in the pipe and to detect the flow amount or flow speed. However, such an alarm device needs to be connected to the system pipe or container, thus potentially increasing the assembly cost and the possibility of water leakage at the connecting points.

Furthermore, an alarm device is provided, which utilities light emitters and light receivers installed in the pipe of the water-cooling heat dissipation system for detecting water flows; when no water flows through the pipe, the light receiver receives an abnormal signal to trigger alarm; whereas such the alarm device might be erroneously enable to issue false alarm actions simply because of some small water flow in the pipe.

### SUMMARY OF THE INVENTION

Regarding to the aforementioned issues, the water-cooling heat dissipation alarm system according to the present invention uses an alarm device to retrieve a frequency signal outputted by a circulation pump in the system, and determines the condition of the water flow in the system based on the retrieved frequency signal, and then further performs alarm operations in accordance with the determined condition in order to generate a precise system abnormality alarm.

The alarm device according to the present invention generates alarm operations based on the frequency signal outputted by the water-cooling heat dissipation system, in which the alarm device comprises a frequency-voltage converter, a first comparator, a first driver, a water shortage alarm device, a second comparator, a second driver and a pump failure alarm device.

Herein the frequency-voltage converter is connected to the water-cooling heat dissipation system to receive the frequency signal, and outputs a voltage signal. The first comparator is connected to the frequency-voltage converter for comparing the outputted voltage signal with a first reference voltage so as to output a first control signal. The first driver is connected to the first comparator, controlled by the first control signal to output a first driving signal. The water shortage alarm device is connected to the first driver, driven by the first driving signal to perform alarm operations. The second comparator is connected to the frequency-voltage converter, comparing the voltage signal with a second reference voltage to output a second control signal. The second driver is connected to a second comparator, controlled by the second control signal to output a second driving signal. The pump failure alarm device is connected to the second driver, controlled by the second driving signal to perform alarm operations.

The water-cooling heat dissipation system according to the present invention comprises a water-cooling heat dissipation system and an above-said alarm device. Herein the water-cooling heat dissipation system is mutually connected by the pipe with a water block, a heat exchanger, a water tank and a circulation pump, in which the circulation pump outputs a frequency signal being in proportional to the rotation speed of the circulation pump. The alarm device is installed in the circulation pump, which receives the frequency signal outputted by the circulation pump and determines the water flow condition and the circulation pump action in the system based on the frequency signal, and then performs alarm operations based on the determined condition so as to generate a precise system abnormality alarm.

The alarm device according to the present invention can precisely determine the conditions in the water flow and operations of the circulation pump based on the frequency signal outputted by the circulation pump. Herein, when (1) the volume of the water flow decreases, the rotation speed of the circulation pump accelerates to generate a frequency signal output of high frequency; (2) when water flow is normal, the rotation speed of the circulation pump is normal as well, thus generating normal frequency signal output; additionally, (3) when the circulation pump fails, no rotation speed exists in the circulation pump, thus stopping the output of the frequency signal.

In this way, the alarm device according to the present invention can be installed on the signal lines of a general circulation pump for receiving the frequency signal outputted by the circulation pump and performing alarm operations in accordance with the frequency signal. Therefore the present invention can save extra connection assembly cost, and eliminate the possibility of water leakage at connecting locations. Meanwhile, according to the determined condition, it can appreciate the conditions in the water flow and the operations of the circulation pump so as to further provide precise system abnormality alarm.

In order to further understand the characteristics and technical contents of the present invention, references are made to the following Detailed Descriptions and append drawings with regards to the present invention; however, the appended drawings are simply for the purposes of reference and illustration, rather than being used as limiting the present invention thereto.

To enable the officers/members in the Patent Review Committee better understanding the inventive characteristics and technical contents of the present application, references are made to the following Detailed Descriptions and append drawings with regards to the present invention; however, the appended drawings are simply for the purposes of reference and illustration, rather than being used as limiting the present invention thereto.

### BRIEF DESCRIPTION OF THE DRAWINGS

FIG. 1 is a structural diagram of a conventional water-cooling heat dissipation system;

FIG. 2 is a functional block diagram of the water-cooling heat dissipation alarm system according to the present invention;

FIG. 3 is a functional block diagram of the alarm device according to the present invention; and

FIG. 4 is a waveform diagram for the operations of the present invention.

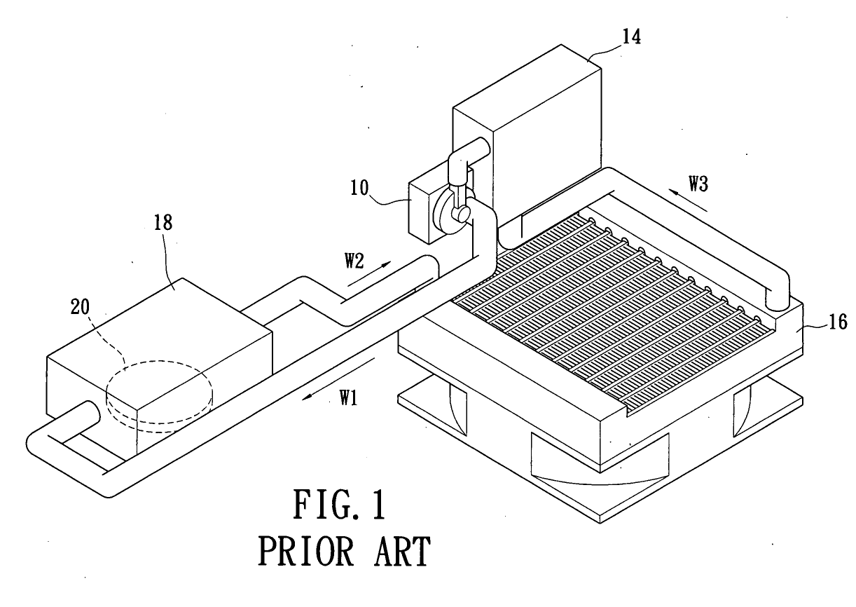

### DETAILED DESCRIPTION OF THE PREFERRED EMBODIMENTS

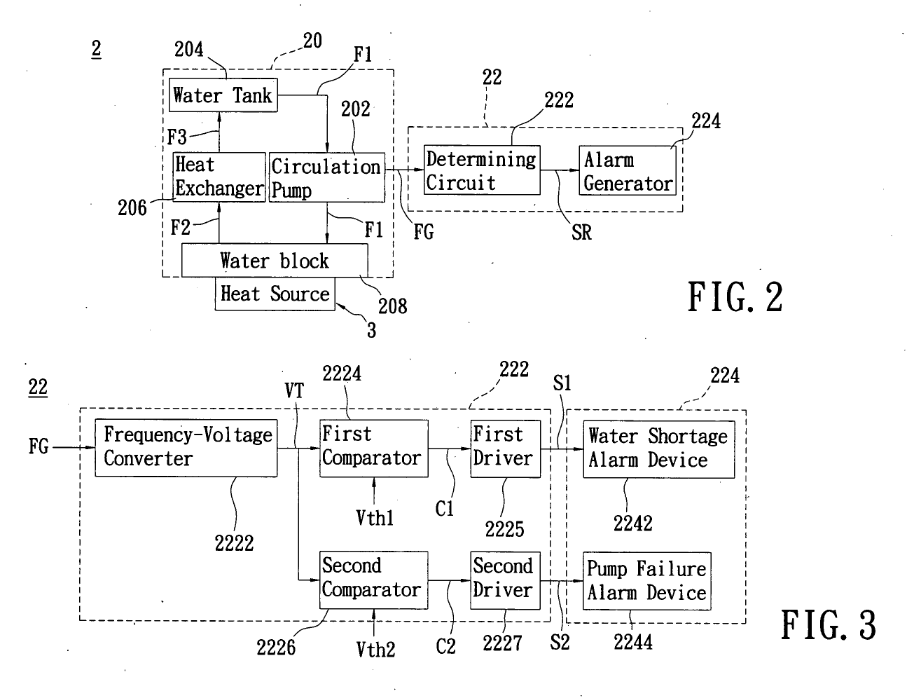

Refer to FIG. 2, wherein a functional block diagram of the water-cooling heat dissipation alarm system according to the present invention is shown. The water-cooling heat dissipation alarm system 2 comprises a water-cooling heat dissipation system 2.0 and an alarm device 22. Herein the water-cooling heat dissipation system 20 is mutually connected to a circulation pump 202, a water tank 204, a heat exchanger 206 and a water block 208.

The water-cooling heat dissipation system 20 employs the operation of the circulation pump 202 to cause the low temperature fluid F1 to flow from the water tank 204 into the water block 208 through the pipe, and the water block 208 is in close proximity of the heat source 3 (e.g. CPU) to perform heat exchange. After the heat exchange, the high temperature fluid F2 flows from the water block 208 through the pipe and into the heat exchanger 206 for heat exchange. After the heat exchange, the constant temperature or low temperature fluid F3, through the pipe, flows from the heat exchanger 206 into the water tank 204, thus forming the circulated water-cooling heat dissipation. Herein the circulation pump 202 outputs a frequency signal FG, and the outputted frequency signal FG is proportional to the rotation speed in the circulation pump 202. When the fluid quantity decreases, the circulation pump 202 accelerates; at this moment the frequency signal FG has high frequency. When the fluid flow is normal, the circulation pump 202 normally rotates and the frequency signal FG has normal frequency. Furthermore, in case the circulation pump 202 fails, rotation speed in the circulation pump 202 is zero, it stops outputting the frequency signal FG.

The alarm device 22 comprises a determining circuit 222 and an alarm generator 224. The determining circuit 222 is connected to the circulation pump 202 to receive the frequency signal FG from the circulation pump 202, and determines the conditions in the fluid flow and the operations of the circulation pump 202 based on the frequency signal FG. The alarm generator 224 is connected to the determining circuit 222 to perform alarm operations based on the determination signal SR from the determining circuit 222, so as to provide precise system abnormality alarm.

Refer to FIG. 3, wherein a functional block diagram of the alarm device according to the present invention is shown. The alarm device 22 comprises a determining circuit 222 and an alarm generator 224, herein the determining circuit 222 consists of a frequency-voltage converter 2222, a first comparator 2224, a first driver 2225, a second comparator 2226 and a second driver 2227. The alarm generator 224 consists of a water shortage alarm device 2242 and a pump failure alarm device 2244, or one of the water shortage alarm device 2242 and a pump failure alarm device 2244. The water shortage alarm device 2242 and a pump failure alarm device 2244 may be a coruscating alarm generator or buzzer.

Refer again to FIG. 3, in conjunction with FIG. 2, wherein the frequency-voltage converter 2222 is connected to the circulation pump 202 in the water-cooling heat dissipation system 20 for receiving the frequency signal FG and outputting a voltage signal VT. The first comparator 2224 is connected to the frequency-voltage converter 2222 for comparing the voltage signal VT with a first reference signal Vth1 to output a first control signal C1. The first driver 2225 is connected to the first comparator and the water shortage alarm device 2242, and is controlled by the first control signal C1 to send the first driving signal S1 to the water shortage alarm device 2242 in order to drive the water shortage alarm device 2242 for alarm operations.

The second comparator 2226 is connected to the frequency-voltage converter 2222, comparing the voltage signal VT with a second reference voltage Vth2 to output a second control signal C2. The second driver 2227 is connected to the second comparator 2226 and the pump failure alarm device 2244, and controlled by the second control signal C2 to send the second control signal C2 to the pump failure alarm device 2244, so as to drive the pump failure alarm device 2244 for alarm operations.

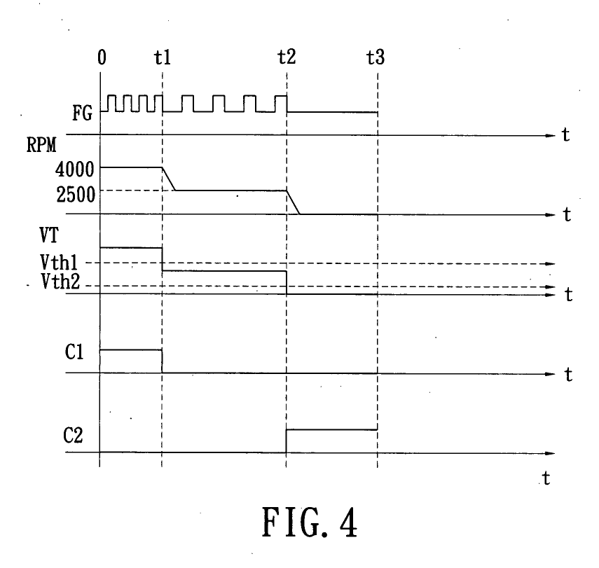

Refer now to FIG. 4, wherein waveform diagram for the operations of the present invention is shown. In this waveform diagram, horizontal axle indicates time (t), vertical axle consists of frequency signal FG, rotation speed in the circulation pump RPM, voltage signal VT, first control signal C1 and second control signal C2. Besides, FIG. 4 presents display examples of various states.

During time 0˜t1, no water flow passes through the circulation pump 202, so the circulation pump 202 generates high speed rotation whose rotation speed is approximately 4000 rpm. At this moment, the circulation pump 202 sends a frequency signal FG of high frequency, and such a frequency signal FG of high frequency is proportional to the rotation speed in the circulation pump 202. Additionally, the frequency voltage converter 2222 converts the frequency signal FG of high frequency into a higher voltage signal VT output, which higher voltage signal VT output is greater than the first reference voltage Vth1; as a result, the first comparator 2224 issues an Enable first control signal C1. In conjunction with FIG. 3, the Enable first control signal C1 controls the first driver 2225 to send a first driving signal S1 to the water shortage alarm device 2242 for driving the water shortage alarm device 2242 to generate an alarm signal.

During t1˜t2, normal amount of water flow passes through the circulation pump 202; hence the circulation pump 202 presents normal rotation speed which is about 2500 rpm. At this moment, the circulation pump 202 sends a frequency signal FG of normal frequency. Besides, the frequency voltage converter 2222 converts frequency signal FG of normal frequency into a normal voltage signal VT output, which normal voltage signal VT output is smaller than the first reference voltage Vth1 but greater than a second reference voltage Vth2; therefore, the first comparator 2224 and the second comparator 2226 respectively transfer Disable first control signal C1 and second control signal C2. Since the first comparator 2224 and the second comparator 2226 both output Disable signals, neither the first driver 2225 nor the second driver 2227 will be driven, and accordingly the water shortage alarm device 2242 and the pump failure alarm device 2244 do not perform alarm operations, indicating the circulation pump 202 is operating under normal condition.

During time t2˜t3, failure occurs in the circulation pump 202, thus the circulation pump 202 stops operating. At this moment, the circulation pump 202 stops send the frequency signal FG. Also, the frequency voltage converter 2222 issues a voltage signal VT output of zero level, which voltage signal VT output of zero level is smaller than the second reference voltage Vth2; as a result the second comparator 2226 sends an Enable second control signal C2. In conjunction with FIG. 3, the Enable second control signal C2 controls the second driver 2227 to send a second driving signal to the pump failure alarm device 2244 for driving the pump failure alarm device 2244 to generate an alarm signal.

In summary, the alarm device according to the present invention can precisely determine the conditions in the water flow and the operations of the circulation pump based on the frequency signal outputted by the circulation pump, and generate alarm operations. Herein (1) when the volume of the water flow decreases, the rotation speed of the circulation pump accelerates to further generate a frequency signal output of high frequency, causing the alarm device to operate; (2) when water flow is normal, the rotation speed of the circulation pump is normal as well, thus generating normal frequency signal output and the alarm device stopping alarm operations based on the normal frequency signal; additionally, (3) when the circulation pump fails, no rotation speed exists in the circulation pump, thus stopping the output of the frequency signal, and at this moment the alarm device generating alarm based on the stopped frequency signal.

As such, the alarm device according to the present invention can be connected to signal lines of a general circulation pump for receiving the frequency signal outputted by the circulation pump, and perform alarm operations based the frequency signal. Therefore, the present invention can eliminate the need for extra connection assembly cost and problems of water leakage and erroneous actions found in conventional alarm devices.

The aforementioned descriptions set out merely the preferred embodiments of the present invention, but the characteristics thereof are by no means limited thereto. All changes or modifications that any skilled ones in the art can conveniently consider in the field of the present invention are deemed to be encompassed by the scope of the present invention defined by the subsequent claims.

What is claimed is:

1. An alarm device, comprising:
at least one alarm generator; and
a determining circuit, which is connected to the alarm generator and a circulation pump in the water-cooling heat dissipation system, the determining circuit receiving a frequency signal and sending a determination signal to the alarm generator, wherein the frequency signal is proportional to the rotation speed of the circulation pump.

2. The alarm device according to claim 1, wherein the alarm generator is a water shortage alarm device.

3. The alarm device according to claim 2, wherein the water shortage alarm device is a coruscating alarm or a buzzer.

4. The alarm device according to claim 2, wherein the determining circuit comprises:
a frequency-voltage converter, which is connected to the circulation pump to receive the frequency signal, and which outputs a voltage signal;
a first comparator, which is connected to the frequency-voltage converter to compare the voltage signal with a first reference voltage so as to output a first control signal; and
a first driver, which is connected to the first comparator and the water shortage alarm device, and receives the first control signal to output a first driving signal to the water shortage alarm device.

5. The alarm device according to claim 4, wherein the first comparator outputs the first control signal when the voltage signal is greater than the first reference voltage.

6. The alarm device according to claim 1, wherein the alarm generator is a pump failure alarm device.

7. The alarm device according to claim 6, wherein the pump failure alarm device is a coruscating alarm or a buzzer.

8. The alarm device according to claim 6, wherein the determining circuit comprises:
a frequency-voltage converter, which is connected to the circulation pump to receive the frequency signal, and outputs a voltage signal;
a second comparator, which is connected to the frequency-voltage converter to compare the voltage signal with a second reference voltage so as to output a second control signal; and
a second driver, which is connected to the second comparator and the pump failure alarm device, and receives the second control signal to output a second driving signal to the pump failure alarm device.

9. The alarm device according to claim 8, wherein the second comparator outputs the second control signal when the voltage signal is smaller than the second reference voltage.

10. The alarm device according to claim 1, wherein the alarm generator comprises a water shortage alarm device and/or a pump failure alarm device.

11. The alarm device according to claim 10, wherein the determining circuit comprises:
a frequency-voltage converter, which is connected to the circulation pump to receive the frequency signal, and outputs a voltage signal;
a first comparator, which is connected to the frequency-voltage converter to compare the voltage signal with a first reference voltage so as to output a first control signal;
a first driver, which is connected to the first comparator and the water shortage alarm device, and receives the first control signal to output a first driving signal to the water shortage alarm device;
a second comparator, which is connected to the frequency-voltage converter to compare the voltage signal with a second reference voltage so as to output a second control signal; and
a second driver, which is connected to the second comparator and the pump failure alarm device, and receives the second control signal to output a second driving signal to the pump failure alarm device.

12. The alarm device according to claim 11, wherein the first comparator outputs the first control signal when the voltage signal is greater than the first reference voltage.

13. The alarm device according to claim 1, wherein the second comparator outputs the second control signal when the voltage signal is smaller than the second reference voltage.

14. The alarm device according to claim 10, wherein the water shortage alarm device is a coruscating alarm or a buzzer.

15. The alarm device according to claim 10, wherein the pump failure alarm device is a coruscating alarm or a buzzer.

16. A water-cooling heat dissipation alarm system, comprising:
a water-cooling heat dissipation system, which is mutually connected by the pipes with a water block, a heat exchanger, a water tank and a circulation pump, in which the circulation pump outputs a frequency signal being in proportional to the rotation speed of the circulation pump;
at least an alarm device, which is connected to the circulation pump, comprising:
an alarm generator; and
a determining circuit, which is connected to the alarm and the circulation pump, the determining circuit receiving a frequency signal and sending a determination signal to the alarm generator.

17. The water-cooling heat dissipation alarm system according to claim 16, wherein the alarm generator comprises a water shortage alarm device and/or a pump failure alarm device.

18. The water-cooling heat dissipation alarm system to claim 17, wherein the determining circuit comprises:
a frequency-voltage converter, which is connected to the circulation pump to receive the frequency signal, and outputs a voltage signal;
a first comparator, which is connected to the frequency-voltage converter to compare the voltage signal with a first reference voltage so as to output a first control signal;
a first driver, which is connected to the first comparator and the water shortage alarm device, and receives the first control signal to output a first driving signal to the water shortage alarm device;
a second comparator, which is connected to the frequency-voltage converter to compare the voltage signal with a second reference voltage so as to output a second control signal; and
a second driver, which is connected to the second comparator and the pump failure alarm device, and receives the second control signal to output a second driving signal to the pump failure alarm device.

19. The water-cooling heat dissipation alarm system according to claim 18, wherein the first comparator outputs the first control signal when the voltage signal is greater than the first reference voltage.

20. The water-cooling heat dissipation alarm system according to claim 18, wherein the second comparator outputs the second control signal when the voltage signal is smaller than the second reference voltage;

21. The water-cooling heat dissipation alarm system according to claim 17, wherein the water shortage alarm device is a coruscating alarm or a buzzer.

22. The water-cooling heat dissipation alarm system according to claim 17, wherein the pump failure alarm device is a coruscating alarm or a buzzer.
